(19) United States
(12) Patent Application Publication
(10) Pub. No.: US 2009/0195516 A1
(43) Pub. Date: Aug. 6, 2009

(54) Sensing Structure of a Display

(75) Inventors: Han Ping Kuo, Hsinchu (TW); Kuang Cheng Cheng, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORP., Hsinchu (TW)

(21) Appl. No.: 12/115,918

(22) Filed: May 6, 2008

(30) Foreign Application Priority Data
Feb. 5, 2008 (TW) 97104533

(51) Int. Cl. G06F 3/044

(52) U.S. Cl. 345/174; 345/173

(57) ABSTRACT

A sensing structure includes a display module, a sensing unit, and a chip. The display module includes an active area. The sensing unit is disposed on the display module and overlaps at least part of the active area. The chip is disposed on the display module and outside the active area.

This application claims priority to Taiwan Patent Application No. 097104533, filed Feb. 5, 2008, the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention relates to a sensing structure; and particularly relates to a sensing structure of a display.

2. Descriptions of the Related Art

The advancement of electro-optical technologies and the digitalization of image technologies have made displays widespread in every day life. Among these displays, liquid crystal displays (LCDs) are widely used in various communication and electronic products due to their advantages such as high definition, light weight, thin profile, low power consumption, and low radiation. In the display market, LCDs have gradually replaced conventional cathode ray tube (CRT) displays.

To enhance the interactivity with the users and the utility of LCDs, some LCDs have touch sensing functions for users to select the desired options by directly touching icons on these displays, or by directly handwriting characters or symbols onto these displays. With the touch sensing function, it is not necessary to reserve some space for the keyboards or other functional buttons in electronic products. Therefore, a larger display panel can be accommodated within electronic products of the same size.

As shown in FIG. 1, in a conventional display field, a sensing structure 1 comprises a display module 11, a touch panel 12, a sensor chip 13, a flexible printed circuit (FPC) 14, and a driver chip 16. The touch panel 12 is attached on the display module 11. The sensor chip 13 is disposed on the FPC 14 and is electrically connected with the touch panel 12 via conductive lines. The sensor chip 13 is adapted to process the sensing signals generated by the touch panel 12 when touched.

FIG. 1 also shows the display module 11 which comprises a color filter substrate 111, a thin film transistor (TFT) array substrate 112, and a liquid crystal layer 114. The liquid crystal layer 114 is packaged between the color filter substrate 111 and the TFT array substrate 112. The driver chip 16 is disposed on the TFT array substrate 112 and also connected with a central control system (not shown) through another FPC 15. The driver chip 16 is adapted to supply the driving voltage for the display module 11 to display an image.

However, the sensing structure 1 has the touch panel 12 to sense the touch. The touch panel 12 is an individual module of the sensing structure 1, and the display module 11 is also an individual module of the sensing structure 1. The touch panel 12 is attached on the display module 11 during the assembly process. In conventional display field, the sensor chip 13 is formed on the FPC 14 before it is electrically connected with the touch panel 12. Such a chip-on-film (COF) process for bonding the sensor chip 13 onto the FPC 14 and subsequent bonding procedures entail a complex manufacturing process and require relatively expensive COF substrates. Therefore, the COF process inevitably leads to a complex process flow and high manufacturing cost.

In view of this, it is highly desirable in the field to provide a sensing structure that can be manufactured by a simple process at a low cost to solve the aforesaid problems encountered in the prior art.

### SUMMARY OF THE INVENTION

One object of the present invention is to provide a sensing structure, in which a sensing unit and a chip is directly disposed on a display module without performing a COF process. The sensing structure of the present invention has a high integration, a relatively simplified manufacturing process, and a low manufacturing cost.

The sensing structure according to the present invention comprises a display module, a sensing unit, and a chip. The display module has an active area. The sensing unit is disposed on the display module and overlaps at least part of the active area. The chip is disposed on the display module and outside the active area, and is electrically connected to the sensing unit. When physically contacted, the sensing unit is adapted to generate and transmit a signal to the chip. The sensing structure may comprise a cover lens, which covers at least part of the sensing unit and is partially formed with a receiving space adapted to receive the chip.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a conventional sensing structure;

FIG. 2 illustrates a sensing structure according to one embodiment of the present invention;

FIG. 3 illustrates a partial top view of the sensing structure according to one embodiment of the present invention;

FIG. 4 illustrates another embodiment of the sensing structure according to the present invention;

FIG. 5 illustrates a cover lens according to the present invention; and

FIG. 6 illustrates the preferred embodiment of the sensing unit according to the present invention.

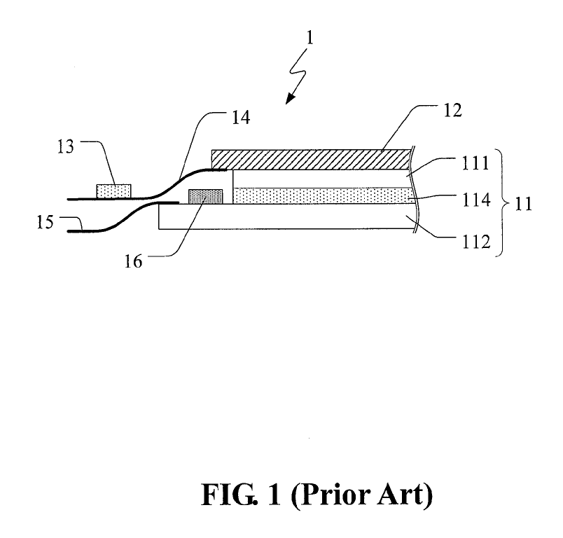

### DESCRIPTION OF THE PREFERRED EMBODIMENT

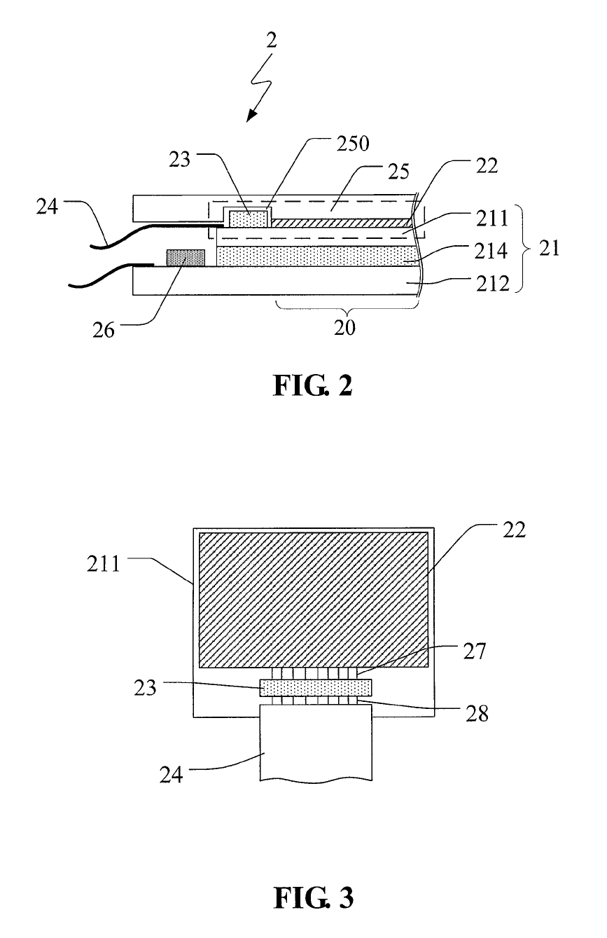

FIG. 2 illustrates a sensing structure 2 disclosed in the present invention which comprises a display module 21, a sensing unit 22 and a chip 23. The display module 21 has an active area 20 to display an image. The sensing unit 22 is disposed on the display module 21 and overlaps at least part of the active area 20. When physically contacted, the sensing unit 22 is adapted to generate a signal.

With reference to FIGS. 2 and 3, FIG. 3 illustrates a top view of an area enclosed by a dotted line in FIG. 2. To clearly depict the connection relationships of the sensing structure components, a cover lens 25 is omitted in FIG. 3. The chip 23 is disposed on the display module 21 and outside the active area 20 to avoid obstructing the image display of the active area 20. The chip 23 is electrically connected with the sensing unit 22. When being touched, the sensing unit 22 is adapted to generate a signal and transmit it to the chip 23 via a plurality of connecting wires 27. Additionally, an FPC 24 has one end extended above the display module 21 and electrically connected with the chip 23 via another plurality of connecting wires 28. Through the FPC 24, the signals processed by the chip 23 are finally transmitted to a central control system (not shown) that is electrically connected with the other end of the FPC 24. The dimensions, numbers, locations and distribution densities of the chip, the FPC and the connecting wires may be changed. One skilled in the art may make appropriate alterations depending on the practical requirements. Therefore, the present invention is not limited to the above description.

The display module 21 of the present invention comprises a first substrate 211 and a second substrate 212 disposed below the first substrate 211. The first substrate 211 may be a color filter substrate, while the second substrate 212 may be a thin film transistor (TFT) array substrate. A liquid crystal layer 214 is packaged between the first substrate 211 and the second substrate 212. The sensing structure 2 may further comprise a driver chip 26 disposed on the second substrate 212. The driver chip 26 is configured to supply a driving voltage for the display module 21 to display an image.

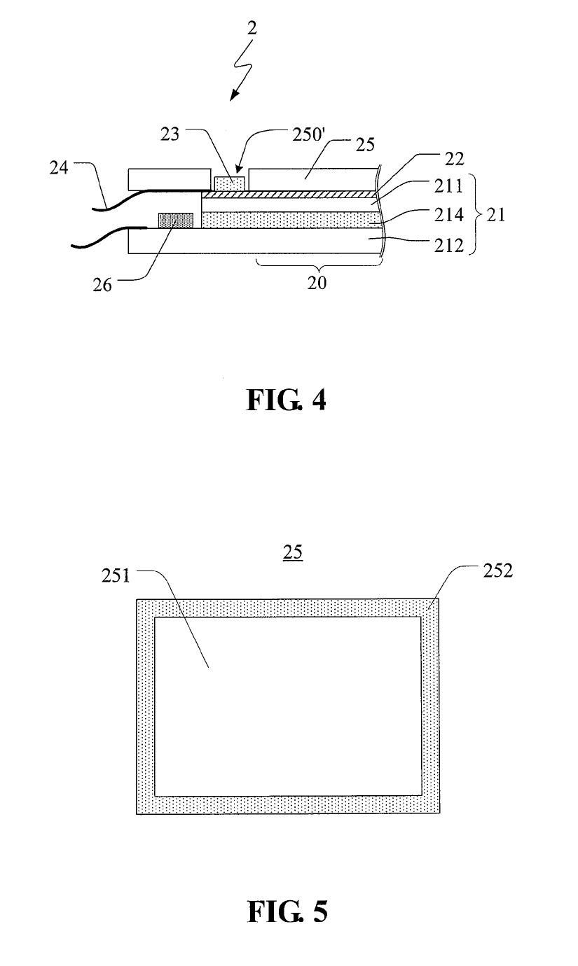

With reference to FIGS. 2 and 3, the chip 23 is disposed on the display module 21 and electrically connected with the sensing unit 22. The ways in which the chip 23 is electrically connected to the sensing unit 22 are as follows. For example, to increase the integration between the chip 23 and the sensing unit 22, the chip 23 may be directly disposed on the first substrate 211 of the display module 21 for receiving signals of the sensing unit 22 via the connecting wires 27. Alternatively, the chip 23 may be directly disposed on the sensing unit 22 as shown in FIG. 4. Because it is not necessary for the sensing structure 2 to perform a COF process for bonding the chip 23 onto the FPC 24, there is a simpler manufacturing process and reduced manufacturing costs. Furthermore, the present invention can be embodied in fine pitch design of the connecting wires layout.

In a preferred embodiment, as shown in FIG. 2, the sensing structure 2 may comprise a cover lens 25 that covers at least part of the sensing unit 22. The cover lens 25 protects the sensing unit 22 and the display module 21. The chip 23 is directly disposed on the display module 21. Hence, to decrease the total thickness of the sensing structure 2 and to planarize the surface of the sensing structure 2, the cover lens 25 may be partially formed with a receiving space 250 to receive the chip 23. Therefore, the disposition of the chip 23 on the display module 21 does not increase the total thickness of the sensing structure 2. The receiving space 250 may be formed by partially thinning the cover lens 25 to form a recess at the location corresponding to the chip 23. Alternatively, as shown in FIG. 4, a through-hole may be formed on the cover lens 25 so as to form a receiving space 250′ for accommodating the chip 23.

Furthermore, the cover lens 25, which is used for protecting the sensing unit 22 and the display module 21, may be made of glass or hard polymer material. However, the above materials are only examples. The present invention is not limited to the above description. One skilled in the art may make appropriate alterations depending on the practical requirements.

As shown in FIG. 5, the cover lens 25 may comprise a body 251 and a border 252. In a preferred embodiment, the body 251 is made of a transparent material, and the body 251 may substantially overlap the active area 20 (FIG. 2) to show images without shelter. On the other hand, the border 252 may be opaque. For example, the border 252 may be printed or coated with a black pigment, adhered with an opaque adhesive tape, or be made of an opaque material. The way of making the border 252 is not limited to the above description. The border 252 lies substantially outside the range of the active area to shield the light and to prevent bright ribbon generated at the edge of the image. The ranges of the body 251 and the border 252 may be altered depending on the practical requirements. Alternatively, the border 252 may not exist in the cover lens 25 and the cover lens 25 is completely transparent.

The sensing unit of the present invention, either a capacitance sensing unit or a resistance sensing unit, may be selected by one skilled in the art depending on the practical requirements. Furthermore, the sensing unit may be a touch panel, a touch unit integrated with a display module, or other appropriate touch units. The touch panel, which is an independent device, can be directly disposed on the display module with an adhesive. The touch unit is integrated with a display module, so the touch function can be directly integrated into the display module during the manufacturing process without disposing an additional touch panel. Therefore, the total thickness of the display module with the integrated touch unit is approximately that of the original display module. In the preferred embodiment, the touch unit integrated with the display module is used as the sensing unit.

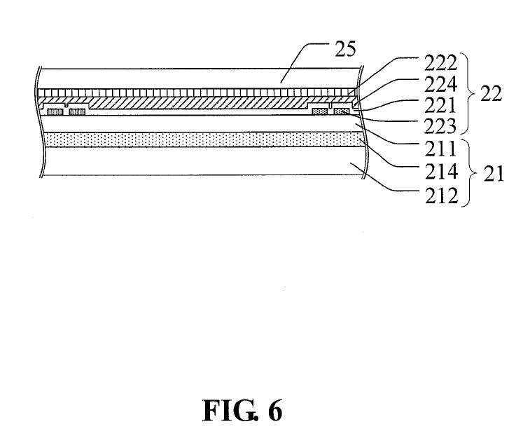

As shown in FIG. 6, the sensing unit 22 may be directly formed on the top surface of the first substrate 211. The sensing unit 22 may comprise a conductive layer 221, a polarizer 222, an electrode layer 223 and a protective layer 224. The electrode layer 223 is formed and patterned on the periphery of the top surface of the first substrate 211. Then the conductive layer 221 is directly formed on the first substrate 211 to cover the electrode layer 223. Additionally, the protective layer 224 may be formed on the conductive layer 221 to protect the conductive layer 221. The polarizer 222 may be formed on the protective layer 224. Alternatively, the protective layer 224 can be omitted and the polarizer 222 is directly attached onto the conductive layer 221. The polarizer can maintain similar protective effect. The electrode layer 223 may be made of molybdenum (Mo)/aluminum (Al) (e.g., an Al layer is formed and then an Mo layer is formed), or of Mo/Al/Mo (e.g., an Mo layer, an Al layer and an Mo layer are formed in sequence). One skilled in the art may choose other proper material for the electrode layer depending on the practical requirements. The conductive layer 221 may be made of various transparent conductive oxides, such as indium tin oxide (ITO), indium oxide, silicon indium oxide, aluminum zinc oxide (AZO), indium zinc oxide (IZO), antimony tin oxide (ATO) or tin oxide. In this embodiment, the conductive layer 221 is preferably made of ITO. The protective layer 224 may be made of silicon nitrides (SiNx). Furthermore, the protective layer 224 may be replaced by the polarizer 222 which is formed directly on the conductive layer 221. Therefore, the functions of polarizer 222 is not only polarizing the light but also protecting the conductive layer 221. The touch unit integrated with the display module is an example of the sensing units. One skilled in the art may choose other kinds of touch units depending on practical requirements.

In conclusion, by directly disposing the chip on the display module, the sensing structure of the present invention can be manufactured through a relatively simpler and cheaper process. Furthermore, the present invention can be made in fine pitch design of the connecting wires layout. Since the cover lens may be stacked on the sensing unit and partially formed with the receiving space to accommodate the chip, the sensing structure will not have an increased thickness due to the disposition of the chip. When the touch unit integrated with the display module is used, the integration of the sensing unit will be further improved and the total thickness of the sensing structure will be reduced. Therefore, the present invention has advantages including total weight reduction, a reduced number of elements, and lowered cost.

The above disclosure is related to the detailed technical contents and inventive features thereof. Persons having ordinary skill in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A sensing structure, comprising:
a display module having an active area;
a sensing unit disposed on the display module and overlapping at least part of the active area; and
a chip disposed on the display module outside the active area and electrically connected with the sensing unit;
wherein the sensing unit is adapted to generate a signal and transmit the signal to the chip while being physically contacted.

2. The sensing structure as claimed in claim 1, wherein the display module comprises a first substrate and a second substrate, in which the first substrate is disposed above the second substrate, and the sensing unit is disposed on the first substrate.

3. The sensing structure as claimed in claim 2, further comprising a driver chip disposed on the second substrate.

4. The sensing structure as claimed in claim 2, wherein the chip is disposed on the first substrate.

5. The sensing structure as claimed in claim 1, where in the chip is disposed on the sensing unit.

6. The sensing structure as claimed in claim 1, wherein the sensing unit comprises a touch panel.

7. The sensing structure as claimed in claim 1, wherein the sensing unit comprises a touch unit integrated with the display module.

8. The sensing structure as claimed in claim 2, wherein the sensing unit is disposed on the top surface of the first substrate.

9. The sensing structure as claimed in claim 2, wherein the sensing unit comprises a conductive layer which is formed on the top surface of the first substrate.

10. The sensing structure as claimed in claim 9, wherein the conductive layer is made of Indium Tin Oxide (ITO).

11. The sensing structure as claimed in claim 9, wherein the sensing unit comprises a protective layer disposed on the conductive layer.

12. The sensing structure as claimed in claim 11, wherein the protective layer comprises a polarizer.

13. The sensing structure as claimed in claim 1, further comprising a cover lens covering at least part of the sensing unit.

14. The sensing structure as claimed in claim 13, wherein the cover lens is partially formed with a receiving space being adapted to receive the chip.

15. The sensing structure as claimed in claim 13, wherein the cover lens comprises a body and a border, the body is made of a transparent material, and the border is made of an opaque material.

16. The sensing structure as claimed in claim 15, wherein the body substantially overlaps the active area, and the border is substantially disposed outside the active area.

17. The sensing structure as claimed in claim 1, further comprising a flexible printed circuit electrically connected with the chip and adapted to transmit the signal from the chip to a central control system.

18. The sensing structure as claimed in claim 1, wherein the sensing unit comprises a capacitance sensing unit or a resistance sensing unit.
